(19) United States
(12) Patent Application Publication
(10) Pub. No.: US 2014/0362029 A1
(43) Pub. Date: Dec. 11, 2014

(54) TOUCH DISPLAY APPARATUS

(71) Applicant: FocalTech Systems, Ltd., Grand Cayman (KY)

(72) Inventors: Lianghua Mo, Shenzhen (CN); Guang Ouyang, Shenzhen (CN)

(73) Assignee: FocalTech Systems, Ltd., Grand Cayman (KY)

(21) Appl. No.: 14/081,276

(22) Filed: Nov. 15, 2013

(30) Foreign Application Priority Data
Jun. 6, 2013 (CN) 201310224524.4

(51) Int. Cl. G06F 3/044

(52) U.S. Cl. CPC G06F 3/044
USPC 345/174

(57) ABSTRACT

A touch display apparatus is provided, which includes: a first substrate; a second substrate arranged in parallel to the first substrate; a liquid crystal layer disposed between the first substrate and the second substrate; and a plurality of touch sensing electrodes which are disposed on the lower surface of the first substrate and arranged in a two-dimensional array. An anti-interference performance may be improved according to the embodiments of the present invention.

### CROSS REFERENCE TO RELATED APPLICATION

This application claims the benefit of priority to Chinese Patent Application No. 201310224524.4, entitled “TOUCH DISPLAY APPARATUS”, filed on Jun. 6, 2013 with State Intellectual Property Office of PRC, which is incorporated herein by reference in its entirety.

### FIELD OF THE INVENTION

This invention relates to the touch technology and in particular to a touch display apparatus.

### BACKGROUND OF THE INVENTION

Currently, capacitive touch screens are widely used to various electronic products, and have prevailed in our work and life. The size of capacitive touch screen is progressively increased, for example, from 2 inches to 6.1 inches of a smart phone, to 10 inches of a tablet computer. The application of capacitive touch screens may extend into smart TV. However, the existing capacitive touch screens generally have the problems of a poor anti-interference performance, a low scanning frame rate, a bulky volume and a complicated manufacturing process.

### SUMMARY OF THE INVENTION

Accordingly, a touch display apparatus is provided according to an embodiment of the disclosure, to solve at least one of the above problems.

The touch display apparatus according to an embodiment of the disclosure includes:

a first substrate;

a second substrate arranged in parallel to the first substrate;

a liquid crystal layer disposed between the first substrate and the second substrate; and

a plurality of touch sensing electrodes, which are disposed on a lower surface of the first substrate and arranged in a two-dimensional array.

Preferably, the touch display apparatus may further include:

a touch control chip, which is bound onto the lower surface of the first substrate and is connected to each of the plurality of touch sensing electrodes through a wire.

Preferably, the touch display apparatus may further include:

a color filter layer, the plurality of touch sensing electrodes being located above, below or in the color filter layer.

Preferably, the wires may be disposed above, below or in the color filter layer, and may be located at a same layer or a different layer as the plurality of touch sensing electrodes.

Preferably, the touch display apparatus may further include:

a black matrix layer, the plurality of touch sensing electrodes being located above or below the black matrix layer.

Preferably, in the touch display apparatus:

the wires are disposed above or below the black matrix layer, and are located at a same layer or a different layer as the plurality of touch sensing electrodes.

Preferably, the plurality of touch sensing electrodes may be combined with the black matrix.

Preferably, the wires are at a same layer or a different layer as the plurality of touch sensing electrodes.

Preferably, the touch display apparatus may further include:

a display control chip, which is configured to be synchronized with the touch control chip such that the displaying and the touch detection of the touch display apparatus are performed at a different time.

Preferably, the touch control chip may be bound onto the lower surface of the first substrate in a chip-on-glass mode.

Preferably, the touch control chip may be configured to detect a self-capacitance of each of the touch sensing electrodes.

Preferably, the touch control chip may be configured to detect a self-capacitance of each of the touch sensing electrodes by:

simultaneously driving other touch sensing electrodes according to a signal applied to the touch sensing electrode; and

simultaneously driving a common electrode in a display module of the touch display apparatus according to the signal applied to the touch sensing electrode.

Preferably, the touch control chip may be configured to determine a touch position according to a two-dimensional capacitance sensing array.

Preferably, the touch display apparatus may be in an in-plane switching structure or a twisted nematic structure.

Preferably, any of the touch sensing electrodes may be square shaped; or

any of the touch sensing electrodes may be strip shaped; or

any of the touch sensing electrodes may be circular; or

any of the touch sensing electrodes may be ellipse shaped; or

any of the touch sensing electrodes may be triangle shaped.

The edges of the touch sensing electrodes are in the concave and convex structure.

Preferably, the material of the plurality of touch sensing electrodes may be indium tin oxide (ITO).

According to the solutions of embodiments of the disclosure, the touch sensing electrodes are arranged in a two-dimensional array, there will be no interference between electrodes, and the superposition of noises is eliminated. Therefore, the noises are significantly decreased and the anti-interference performance is improved.

### BRIEF DESCRIPTION OF THE DRAWINGS

Technical solutions of the embodiments of the present applicant and/or the prior art will be illustrated more clearly with the following brief description of the drawings. Apparently, the drawings referred in the following description are only some of embodiments of the invention, and other drawings may be obtained by the skilled in the art without any creative effort.

FIG. 1 is a schematic diagram of a touch display apparatus according to a first embodiment of the present disclosure;

FIG. 2 is a schematic diagram of a touch display apparatus according to a second embodiment of the present disclosure;

FIG. 3 is a schematic diagram of a touch display apparatus according to a third embodiment of the present disclosure; and

FIG. 4 is a schematic diagram of a touch display apparatus according to a fourth embodiment of the present disclosure.

### DETAILED DESCRIPTION OF THE INVENTION

For better understanding of the object, features and advantage of the present disclosure, the technical solutions according to the embodiments of the present disclosure will be described in conjunction with the drawings. Apparently, the described embodiments are only some of the embodiments. Based on the embodiments of the present disclosure, any other embodiments obtained by the skilled in the art without any inventive labor fall within the protection scope of the invention. For the purpose of explanation, the structural diagram is not drawn to scale but is partially enlarged. Further, the drawings are only exemplary and are not to be taken as a limitation on the protection scope of the invention. In addition, 3-D dimension including length, width and depth may be considered in the practical manufacture.

### First Embodiment

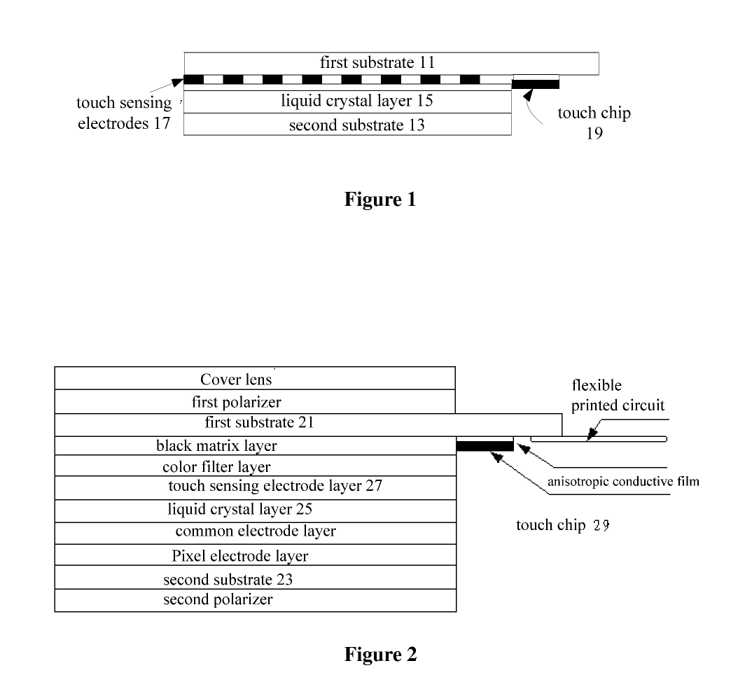

A touch display apparatus is provided according to the first embodiment of the present disclosure. As shown in FIG. 1, the touch display apparatus includes:

a first substrate 11; a second substrate 13 arranged in parallel to the first substrate; a liquid crystal layer 15 disposed between the first substrate 11 and the second substrate 13; and a plurality of touch sensing electrodes 17 disposed on the lower surface of the first substrate 11 and arranged in a two-dimensional array.

The two-dimensional array formed by the plurality of touch sensing electrodes 17 may be a rectangle-shaped array or other arrays in a similar shape. Each of the touch sensing electrodes may be regular polygon (e.g., square) shaped, strip shaped, circular, ellipse shaped, triangle shaped and so on, and may be toothed at the edge.

Preferably, the material of the plurality of touch sensing electrodes 17 may be metal oxide such as indium tin oxide (ITO).

For the capacitive touch screen, each of the touch sensing electrodes is a capacitive sensor of which the capacitance is changed when a corresponding position on the screen is touched. The multi-point touch is achieved by adopting the plurality of touch sensing electrodes arranged in a two-dimensional array. Moreover, in the existing touch display screen, the touch sensing electrodes include row electrodes and column electrodes, and noises of each row or column will be superimposed. For example, when multiple fingers are placed on a same row or column, power noises caused by individual fingers may be superimposed on each other. The more the placed fingers, the greater the superimposed noise will be. However, in the display touch screen according to this embodiment, the touch sensing electrodes (i.e., the touch sensing electrodes in the touch sensing stage) are arranged in a two-dimensional array, each of the touch sensing electrodes is one unit in the two-dimensional array, and there is no interference between the units. Matrix units in each row or each column are different, which may not cause the superposition of noises. Therefore, for the touch display apparatus according to the embodiment of the disclosure, the amplitude of the maximum noise is significantly reduced and the signal to noise ratio (SNR) is improved.

The touch display apparatus may further include a touch control chip 19, which is bound onto the lower surface of the first substrate 11 and is connected to each of the plurality of touch sensing electrodes 17 via wires. The touch control chip 19 may be bound onto the lower surface of the first substrate 11 with the chip-on-glass mode.

The touch control chip has a number of pins for being connected to each of the touch sensing electrodes via wires. Therefore, the touch control chip may be bound onto the first substrate to avoid the difficulty of conventional packaging and the increased chip size and increased packaging cost due to the large number of pins. In addition, by means of bonding such as the COG (Chip on Glass), the touch control chip is in combination with the first substrate as a whole, and the entire size is reduced as compared to the prior art in which the touch control chip is connected to the touch screen by a flexible printed circuit (FPC). Furthermore, since the touch sensing electrodes are generally formed by etching a conductive layer (e.g., a metal oxide such as ITO, or a metal) on the substrate, and the touch control chip is also on the same substrate, the connection wires between the touch sensing electrodes and the touch control chip may be also formed in one process with the etching of the conductive layer, and the manufacturing process is simplified.

Preferably, the touch position may be determined by detecting a self-capacitance of each of the touch sensing electrodes. As an example, the self-capacitance of each of the touch sensing electrodes may be the capacitance to ground of the touch sensing electrode.

Preferably, the touch control chip 19 may be configured to detect a self-capacitance of each of the touch sensing electrodes.

For each of the touch sensing electrodes, simultaneously the touch control chip 19 may drive peripheral or other touch sensing electrodes according to the signal used in driving the current touch sensing electrode while driving the current touch sensing electrode. In this way, the voltage difference between the current sensing electrode and peripheral or other touch sensing electrodes may be decreased, which is advantageous for reducing the capacitance of the current sensing electrode and avoiding a false touch due to a water drop.

Further, for each of the touch sensing electrodes, simultaneously the touch control chip 19 may drive a common electrode in a display module of the touch display apparatus according to the signal used in driving the current touch sensing electrode while driving the current touch sensing electrode. Therefore, the capacitance between the touch sensing electrode and the common electrode is reduced and a relative variation in the capacitance is increased, so as to improve the SNR.

As an example, the touch control chip 19 may include: a driving/receiving unit configured to drive each of touch sensing electrodes and receive sensing data from each of touch sensing electrodes; and a signal processing unit configured to determine the touch position according to the sensing data. Particularly, the driving/receiving unit may be configured to: for each of the touch sensing electrodes, simultaneously drive other touch sensing electrodes according to the signal applied to the touch sensing electrode. Alternatively, the receiving/receiving unit may be configured to: for each of the touch sensing electrodes, simultaneously drive a common electrode in the display module of the touch display apparatus according to the signal applied to the touch sensing electrode.

Preferably, the touch control chip 19 (e.g., the signal processing unit of the touch control chip 19) may be configured to determine the touch position according to the two-dimensional capacitance sensing array.

Preferably, the touch display apparatus may further include a display control chip which is configured to be synchronized with the touch control chip such that the displaying of the touch display apparatus is performed at a different time from the touch detection of the touch display apparatus. That is, the display control chip and the touch control chip operate in a time-sharing way. During the displaying, the display control chip operates normally, and the operation of the touch control chip is stopped. During the touch detection, the operation of the display control is stopped and the touch control chip operates normally. The displaying is not overlapped with the touch detection avoid mutual interference.

In addition, the touch display apparatus may be in an in-plane switching (simply referred to as IPS) structure or a twisted nematic (simply referred to as TN) structure.

The touch display apparatus may include a color filter layer and a black matrix layer. The color filter layer may include a red, green and blue three-color filter layer. The layer of the touch sensing electrodes, the layer of the wires, the red, green and blue three-color filter layer of the color filter layer and the black matrix layer may be configured flexibly. For example, the black matrix layer may be disposed above the red, green and blue three-color filter layer of the color filter layer. The layers of the touch sensing electrodes and the wires may be disposed above or below the black matrix layer, or may be disposed above, below or in the red, green and blue three-color filter layer of the color filter layer. The layer of the touch sensing electrodes may be at a different layer from the wires.

Furthermore, the touch display apparatus may include a cover lens and a light shielding layer. The cover lens may be a thin film made of materials such as glass, Polyethylene Terephthalate (PET), Polycarbonate (PC) or Polymethylmethacrylate (PMMA). The light shielding layer is attached to the lower surface of the cover lens and may be made of differently colored inks or a light shielding material that may be effectively combined with the cover lens, so as to shield the wires and the touch control chip below the light shielding layer.

### Second Embodiment

FIG. 2 is a schematic diagram of a touch display apparatus according to the embodiment of the disclosure. As shown in FIG. 2, the touch display apparatus includes: a cover lens, a first polarizer, a first substrate 21, a black matrix layer, a color filter layer, a touch sensing electrode layer 27, a liquid crystal layer 25, a common electrode layer, a pixel electrode layer, a second substrate 23 and a second polarizer. The touch display apparatus may further include a touch control chip 29.

The touch control chip 29 may be bound onto the lower surface of the first substrate 21 in the chip-on-glass (COG) mode. As an example, an anisotropic conductive film (ACF) may be disposed between the touch control chip 29 and the first substrate 21.

In this embodiment, the touch sensing electrodes are disposed below the color filter layer. Wires connected to the touch sensing electrodes may be at a same layer as the touch sensing electrodes; or may be at a different layer from the touch sensing electrodes and connected to the touch sensing electrodes via through holes. When the wires are at a different layer from the touch sensing electrodes, the wires may be disposed above or below the color filter layer, or may be in the red, green and blue three-color filter layer of the color filter layer.

As an example, the touch display apparatus may be connected to the host by a flexible printed circuit.

The description for other contents of this embodiment may be referred to the first embodiment and will not be repeated.

### Third Embodiment

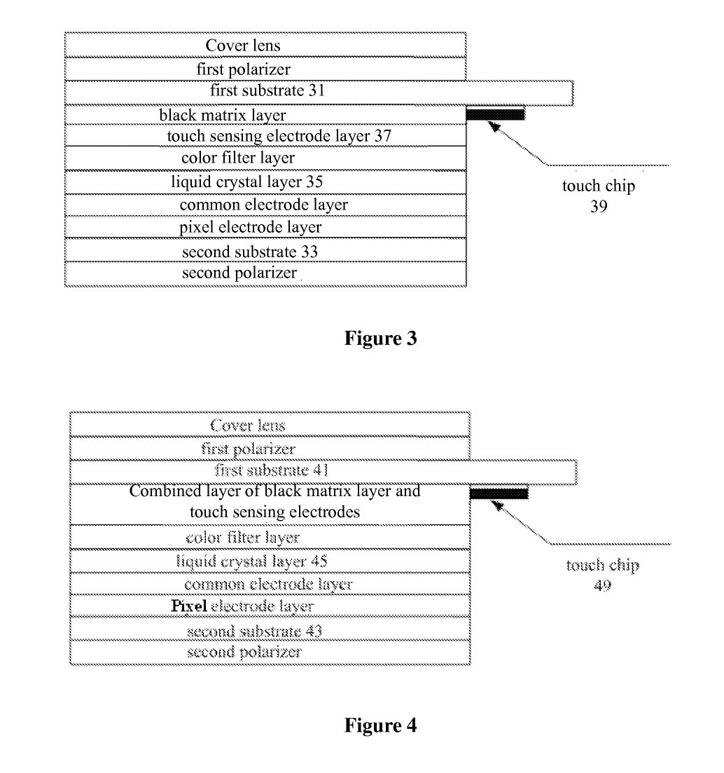

FIG. 3 is a schematic diagram of the touch display apparatus according to this embodiment of the disclosure. As shown in FIG. 3, the touch display apparatus may include: a cover lens, a first polarizer, a first substrate 31, a black matrix layer, a touch sensing electrode layer 37, a color filter layer, a liquid crystal layer 35, a common electrode layer, a pixel electrode layer, a second substrate 33 and a second polarizer. The touch display apparatus may further include a touch control chip 39.

In this embodiment, the touch sensing electrodes may be disposed between the color filter layer and the black matrix layer. Wires connected to the touch sensing electrodes may be at a same layer as the touch sensing electrodes, or may be at a different layer from the touch sensing electrodes and connected to the touch sensing electrodes via through holes. When the wires are at a different layer from the touch sensing electrodes, the wires may be disposed above or below the color filter layer, or may be in the red, green and blue three-color filter layer of the color filter layer. Furthermore, the wires may be disposed above or below the black matrix layer, or alternatively, the black matrix layer may be reused as the wires.

The description of other contents of this embodiment may be referred to the first embodiment, and will not be repeated.

### Fourth Embodiment

FIG. 4 is a schematic diagram of a touch display apparatus according to the fourth embodiment of the disclosure. As shown in FIG. 4, the touch display apparatus includes a cover lens, a first polarizer, a first substrate 41, a combined layer 47 of black matrix layer and touch sensing electrodes, a color filter layer, a liquid crystal layer 45, a pixel electrode layer, a second substrate 43 and a second polarizer. The touch display apparatus may further include a touch control chip 49.

In this embodiment, the touch sensing electrode layer is in combination with the black matrix layer. As an example, the black matrix layer may be made of black conductive materials and may be configured to be in a two-dimensional array structure in which each unit of the array is one touch sensing electrode.

Wires connected to the touch sensing electrodes may be at a same layer as the touch sensing electrodes, or may be at a different layer from the touch sensing electrodes and connected to the electrode layer via through holes. When the wires are at a different layer from the touch sensing electrodes, the wires may be disposed above or below the color filter layer, or may be disposed in the red, green and blue three-color filter layer of the color filter layer.

The illustration for each of the embodiments in the specification emphasizes on the differences from one embodiment to another, and the same or similar contents between the embodiments may be referred to each other.

The invention may be practiced or applied by those skilled in the art based on the above illustration for the disclosed embodiments. Various modifications to the embodiments are apparent for the skilled in the art. The general principle suggested herein can be implemented in other embodiments without departing from the spirit or scope of the invention. Therefore, the present invention should not be limited to the embodiments disclosed herein, but has the widest scope that is conformity with the principle and the novel features disclosed herein.

1. A touch display apparatus comprising:
a first substrate;
a second substrate arranged in parallel to the first substrate;
a liquid crystal layer disposed between the first substrate and the second substrate; and
a plurality of touch sensing electrodes which are disposed on a lower surface of the first substrate and arranged in a two-dimensional array.

2. The touch display apparatus according to claim 1, further comprising:
a touch control chip, which is bound onto the lower surface of the first substrate and is connected to each of the plurality of touch sensing electrodes through a wire.

3. The touch display apparatus according to claim 1, further comprising:
a color filter layer, wherein the plurality of touch sensing electrodes are located above or below the color filter layer.

4. The touch display apparatus according to claim 3, wherein the wires are disposed above, below or in the color filter layer, and are located at a same layer or a different layer as the plurality of touch sensing electrodes.

5. The touch display apparatus according to claim 1, further comprising:
a black matrix layer, wherein the plurality of touch sensing electrodes are located above or below the black matrix layer.

6. The touch display apparatus according to claim 5, wherein the wires are disposed above or below the black matrix layer, and are located at a same layer or a different layer as the plurality of touch sensing electrodes.

7. The touch display apparatus according to claim 1, wherein the plurality of touch sensing electrodes are combined with a black matrix.

8. The touch display apparatus according to claim 7, wherein the wires are located at a same layer or a different layer as the plurality of touch sensing electrodes.

9. The touch display apparatus according to claim 2, further comprising:
a display control chip configured to be synchronized with the touch control chip, allowing the displaying and the touch detection of the touch display apparatus to be performed at a different time.

10. The touch display apparatus according to claim 2, wherein the touch control chip is bound onto the lower surface of the first substrate with the chip-on-glass mode.

11. The touch display apparatus according to claim 1, wherein the touch control chip is configured to detect a self-capacitance of each of the touch sensing electrodes.

12. The touch display apparatus according to claim 11, wherein the touch control chip is configured to detect a self-capacitance of each of the touch sensing electrodes by:
simultaneously driving other touch sensing electrodes according to a signal applied to the touch sensing electrode; and
simultaneously driving a common electrode in a display module of the touch display apparatus according to the signal applied to the touch sensing electrode.

13. The touch display apparatus according to claim 11, wherein the touch control chip is configured to determine a touch position according to a two-dimensional capacitance sensing array.

14. The touch display apparatus according to claim 1, wherein the touch display apparatus is in an in-plane switching structure or a twisted nematic structure.

15. The touch display apparatus according to claim 1, wherein,
any of the touch sensing electrodes is square shaped; or
any of the touch sensing electrodes is strip shaped; or
any of the touch sensing electrodes is circular; or
any of the touch sensing electrodes is ellipse shaped; or
any of the touch sensing electrodes is triangle shaped.

16. The touch display apparatus according to claim 1, wherein the edges of the touch sensing electrodes are in the concave and convex structure.

17. The touch display apparatus according to claim 1, wherein the plurality touch sensing electrodes are made of indium tin oxide.
